(19) United States
(12) Patent Application Publication
(10) Pub. No.: US 2006/0044605 A1
(43) Pub. Date: Mar. 2, 2006

(54) Systems, methods and computer program products for labeled forms processing

(76) Inventors: Charles R. Schneider, Alpharetta, GA (US); Kenneth W. Oringer, Short Hills, NJ (US); James P. Boylan JR., Brunswick, OH (US)

Correspondence Address: SUTHERLAND ASBILL & BRENNAN LLP, 999 PEACHTREE STREET, N.E., ATLANTA, GA, 30309, US

(21) Appl. No.: 11/210,365

(22) Filed: Aug. 24, 2005

Related U.S. Application Data
(60) Provisional application No. 60/603,946, filed on Aug. 24, 2004.

(51) Int. Cl. G06F 3/12

(52) U.S. Cl. 358/1.15

(57) ABSTRACT

A system, method, and computer product for processing paper documents for electronic storage and retrieval where a label containing a document identification code is generated and is affixed to a paper document. The paper document is then converted to a digital format and transmitted to a central processing center. The digital document is separated into two or more individual pages and may be presented to a user with a viewer program. Through the viewer program the user may then identify a portion of the label to image and convert the imaged portion of the label to textual data relating to the document and its contents. The textual data may then be used in archiving the documents in an archiving program. The data also may be retrieved from a stored database location and verified with information entered in a particular field by a user.

### CROSS-REFERENCE TO RELATED APPLICATIONS

This application claims the benefit of priority to United States provisional patent application Ser. No. 60/603,946 entitled, Systems, Methods and Computer Program Products for Labeled Forms Processing, which was filed in the United States Patent and Trademark Office on Aug. 24, 2004, the specification and attachments of which are hereby incorporated by reference.

### FIELD OF THE INVENTION

The present invention generally relates to a web-based software application that manages and automates information capture systems. More specifically, the present invention relates to systems, methods, and computer program products for processing and archiving electronic documents.

### BACKGROUND OF THE INVENTION

Many of the most important documents within government entities and business are in paper format. Digitalizing these paper documents enables fast and efficient storage of these documents where they can presumably be preserved forever. As a result, there have been attempted solutions to provide document capture systems that digitize these documents in an automated fashion. Currently, there are generally two types of files created when converting paper documents into digital files: (1) bitmap images saved as a digital file in an image format such as PDF, usually the result of scanning the document, and (2) text-based documents generated by processing an image file with OCR software where the text of a document can be “read” from the image and converted into word processing text. Paper documents once captured in an electronic format usually need to be organized, structured, processed, and/or stored for subsequent retrieval. It is known that various user programs exist to handle these tasks. One such system is the data capture system Teleform®, a product of Verity, Incorporated.

Teleform® is used in conjunction with a fax server (e.g., a RightFax server) which is known to run software that converts paper documents into the electronic documents in a .txt file format. Teleform® and programs like it combine the electronic data capture of paper documents into .txt files with an automated software solution that captures, extracts, verifies, processes, indexes, and archives large quantities of documents by converting them. However, a problem with programs like Teleform® is that they are prone to misalignment as the forms are being processed into text documents, resulting in erroneous conversions of image data into text. This is often the result of the document being reduced or enlarged in size. Because it is difficult to recognize such misalignment problems, they often go undetected and unresolved. In addition, Teleform® and other similar programs are expensive to purchase, require significant processing power and are not easily customized to each user's particular need.

### BRIEF SUMMARY OF THE INVENTION

According to an embodiment of the invention, there is disclosed a method for processing paper documents for electronic storage and retrieval. The method includes generating a label to be associated with a document, where the label includes at least one character string containing readable text with a portion that is encoded. The method further includes associating the label with the document; converting the document to a digital format; transmitting the digital document to a central processing center; separating the digital document into two or more individual pages;

presenting the digital document to a user with a viewer program. The method further includes receiving user input identifying a certain portion of the label; imaging that portion of the label; converting the imaged portion of the label to textual data relating to the document and contents and populating data fields of an archiving program with the textual data for use in archiving the document.

In another embodiment of the invention, the encoded readable text on the label includes a document identification code that may include various types of identifying data such as form types, page numbers and personal identification data. In yet another embodiment of the invention, the document identification code includes at least 15 characters.

In another embodiment of the invention, the label is affixed to the paper document. In yet another embodiment of the invention, the digital format of the converted document is PDF. In yet another embodiment of the invention, when the digital document is separated into two or more individual pages each individual page is formatted as a separate PDF file.

In another embodiment of the invention, the viewer program for presenting the digital document to a user is a web browser. In yet another embodiment of the invention, converting the imaged portion of the label to textual data includes pasting the textual data to a clipboard, parsing the textual data off the clipboard and inserting it into at least one predetermined field. In yet another embodiment of the invention, the step of correcting the textual data that is populating the data fields is added to the method.

According to an embodiment of the invention, there is disclosed a method for processing paper documents for electronic storage and retrieval. The method includes generating a label to be associated with a document, where the label includes at least one character string containing readable text with a portion that is encoded. The method further includes associating the label with the document; converting the document to a digital format; transmitting the digital document to a central processing center; separating the digital document into two or more individual pages; presenting the digital document to a user with a viewer program. The method further includes receiving user input identifying a certain portion of the label; imaging that portion of the label; converting the imaged portion of the label to textual data relating to the document and contents and populating data fields of an archiving program with the textual data for use in archiving the document. The method further includes validating the captured data.

In another embodiment of the invention, the validation of the captured data includes comparing information in a particular field of an operative database interface to a specific field in a database. In yet another embodiment of the invention, the method further includes correcting data in the particular filed of an operative database interface.

In another embodiment of the invention, the method further includes retrieving the stored digital document from the database. In yet another embodiment of the invention where retrieving the stored digital document includes filling out a form containing one or more fields that is connected to the database.

According to an embodiment of the invention, there is disclosed a system for processing paper documents for electronic storage and retrieval. The system includes at least one scanning device for converting a paper document into an electronic document; a central processing center that communicates with at least one scanning device over a network. The central processing center contains, at least one server, at least one central computer, and at least one workstation. In the system, at least one workstation contains a user interface for accessing, through the at least one server, one or more software applications stored in one or more database associated with one or more central computers. The software applications contain executable instructions for performing the following functions on one or more central computers: (1) presenting the electronic document to a user; (2) receiving user input identifying a certain portion of a label associated with the electronic document and imaging that portion of the label; (3) converting the imaged portion of the label to textual data relating to the electronic document and its contents; and (4) populating data fields of an archiving program stored on one or more databases with the textual data for use in archiving the document.

In another embodiment of the invention, the network is the Internet. In yet another embodiment of the invention, one or more workstation are located remote from the central processing center and communicate with the central processing center over a secured network connection.

In another embodiment of the invention, the central processing center includes a private branch exchange, which receives data from the one or more scanners over the network and routes the received data to the one or more servers of the central processing center. In yet another embodiment of the invention, one or more servers of the central processing center convert the electronic document to PDF format and send it to a predetermined database location associated with the one or more central computers of the central processing center.

### BRIEF DESCRIPTION OF THE DRAWINGS

Having thus described the invention in general terms, reference will now be made to the accompanying drawings, which are not necessarily drawn to scale, and wherein:

FIG. 1A is a schematic illustration of a system in accordance with an embodiment of the present invention for scanning and archiving electronic documents.

FIGS. 1B-1D illustrate a flow chart of a process in accordance with an embodiment of the present invention for creating, scanning, and archiving electronic documents.

FIG. 2 illustrates a graphical interface of a software program for creating labels from and for all types of forms in accordance with an embodiment of the present invention for scanning and archiving electronic documents.

FIG. 3 illustrates an embodiment of a set of printed labels each containing three strings of alpha-numeric text in accordance with an embodiment of the present invention for scanning and archiving electronic documents.

FIG. 4 illustrates a graphical interface for a workstation user to navigate a database or directory location where PDF files are stored and select a PDF file to process from a queue in accordance with an embodiment of the present invention for scanning and archiving electronic documents.

FIG. 5 illustrates a data structure for storage of PDF files at a central processing center in accordance with an embodiment of the present invention for scanning and archiving electronic documents.

FIG. 6 illustrates a web browser and for accessing a Document Processing Program of a central processing center through a URL in accordance with an embodiment of the present invention for creating, scanning, and archiving electronic documents.

FIG. 7 illustrates a password protected web page for accessing the Document Processing Program in accordance with an embodiment of the present invention for creating, scanning, and archiving electronic documents.

FIG. 8-10 illustrate the a split screen graphical interface of the Document Processing Program containing a document viewing area for view a PDF document and an operative database interface containing functions for the Document Processing Program in accordance with an embodiment of the present invention for creating, scanning, and archiving electronic documents.

FIG. 11 illustrates a web browser and for accessing a Document Retrieval Program stored on a central processing center through a URL in accordance with an embodiment of the present invention for creating, scanning, and archiving electronic documents.

FIG. 12 illustrates a password protected web page for accessing the Document Retrieval Program in accordance with an embodiment of the present invention for creating, scanning, and archiving electronic documents.

FIG. 13-15 illustrate the a graphical interface containing a form that connects to a database associated with the central processing center for query and retrieval of the sought document in accordance with an embodiment of the present invention for creating, scanning, and archiving electronic documents.

### DETAILED DESCRIPTION OF THE INVENTION

The present invention is directed to systems and methods and computer program products for accurately processing paper documents and, in particular, for electronically storing in a searchable format certain data contained in those documents. In a preferred embodiment, a label is affixed to a paper document containing text or other markings, wherein certain information from the paper document is provided on the label affixed thereto. A portion or all of the information on the label may be encoded. The document and label are then scanned (or faxed) to obtain an electronic copy of the document and that electronic document is transferred to a central processing center. The electronic document, in whole or in part, is referred to throughout this detailed description of the invention as an electronic document, form, digital document data, and imaged document.

At the central processing location, a workstation user may log-in to a central computer to access the electronic copy of the document and the software tools to process the same. The user may view the electronic copy of the document and select a portion of the imaged document that includes at least a portion of the label. The selected portion of the document is processed so that the image converted to text and can be utilized to automatically fill in data fields of a database record associated with the document. For example, if one of the data fields to be filled in is a social security number, then the selected portion of the label is converted to text, and the software program identifies the portion of the text that is the social security number and then fills in the corresponding data field. Although in some instances, validation programs may check the extracted data against other data stored in a database, the workstation user is provided with the imaged document and a data entry screen so she may alter the information automatically filled into the data fields from the selected portion of the image document (e.g., a portion of the label) if the conversion is incorrect.

The present invention will now will be described more fully hereinafter with reference to the accompanying figures, in which some, but not all embodiments of the invention are shown. Indeed, the present invention may be embodied in many different forms and should not be construed as limited to the embodiments set forth herein. Rather, these embodiments are provided so that this disclosure will satisfy applicable legal requirements.

The present invention is described below with reference to flowcharts and graphical interfaces of systems, methods, apparatuses and computer program products according to an embodiment of the invention. It will be understood that each graphical interface, each block of the flowcharts, and combinations of blocks in the flowcharts, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functionality of each graphical interface, each block of the flowcharts, and combinations of blocks in the flowcharts discussed in detail in the descriptions below.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the graphical interfaces, block, or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the graphical interfaces, block, or blocks.

Accordingly, blocks of the flowcharts support combinations of means for performing the specified functions, combinations of steps for performing the specified functions and program instruction means for performing the specified functions. It will also be understood that each graphical interface, each block of the flowcharts, and combinations of blocks in the flowcharts, can be implemented by special purpose hardware-based computer systems that perform the specified functions or steps, or combinations of special purpose hardware and computer instructions.

The inventions may be implemented through an application program running on an operating system of a computer. The inventions also may be practiced with other computer system configurations, including hand-held devices, multiprocessor systems, microprocessor based or programmable consumer electronics, mini-computers, mainframe computers, etc. Application programs that are components of the invention may include routines, programs, components, data structures, etc. that implement certain abstract data types, perform certain tasks, actions, or tasks. In a distributed computing environment, the application program (in whole or in part) may be located in local memory, or in other storage. In addition, or in the alternative, the application program (in whole or in part) may be located in remote memory or in storage to allow for the practice of the inventions where tasks are performed by remote processing devices linked through a communications network. Exemplary embodiments of the present invention will hereinafter be described with reference to the figures, in which like numerals indicate like elements throughout the several drawings.

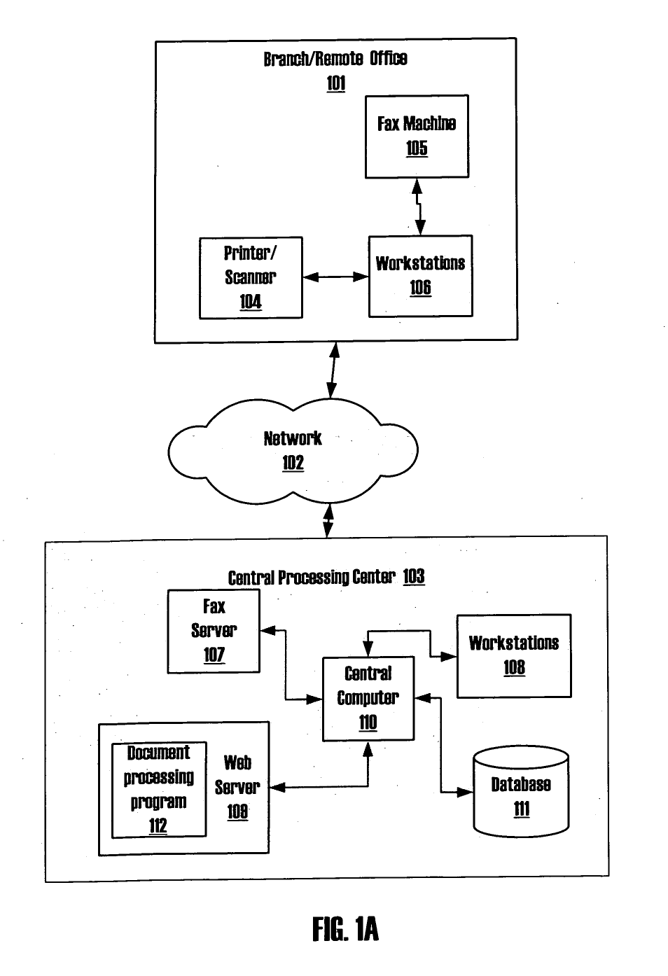

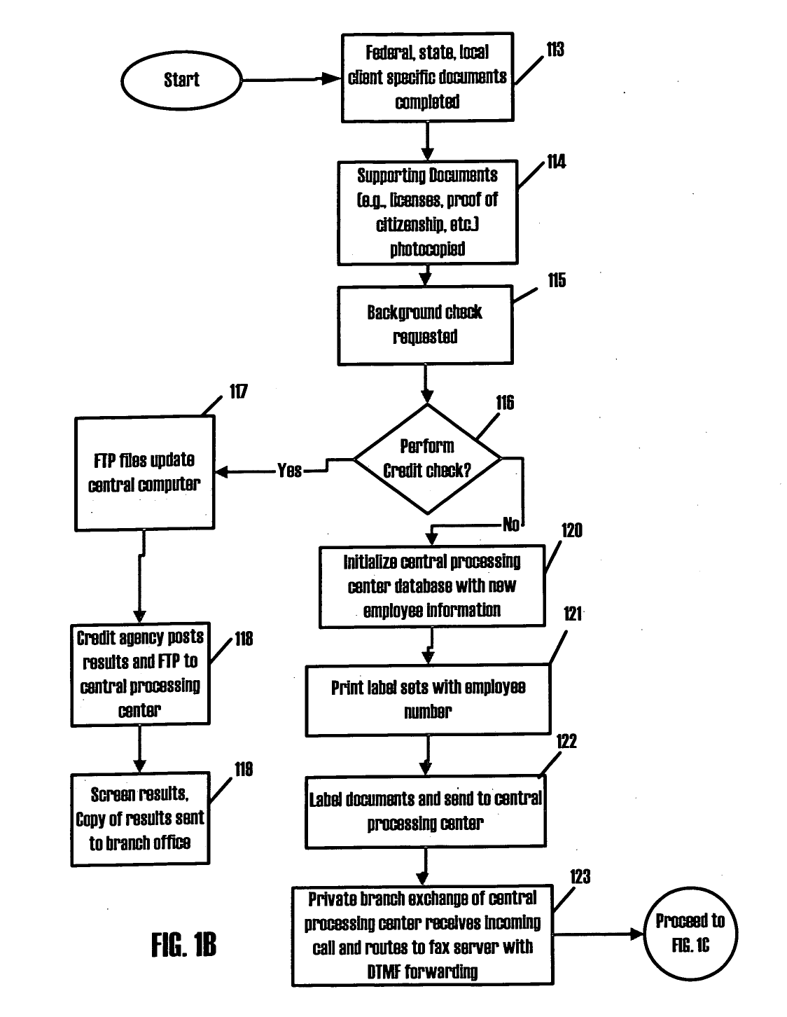

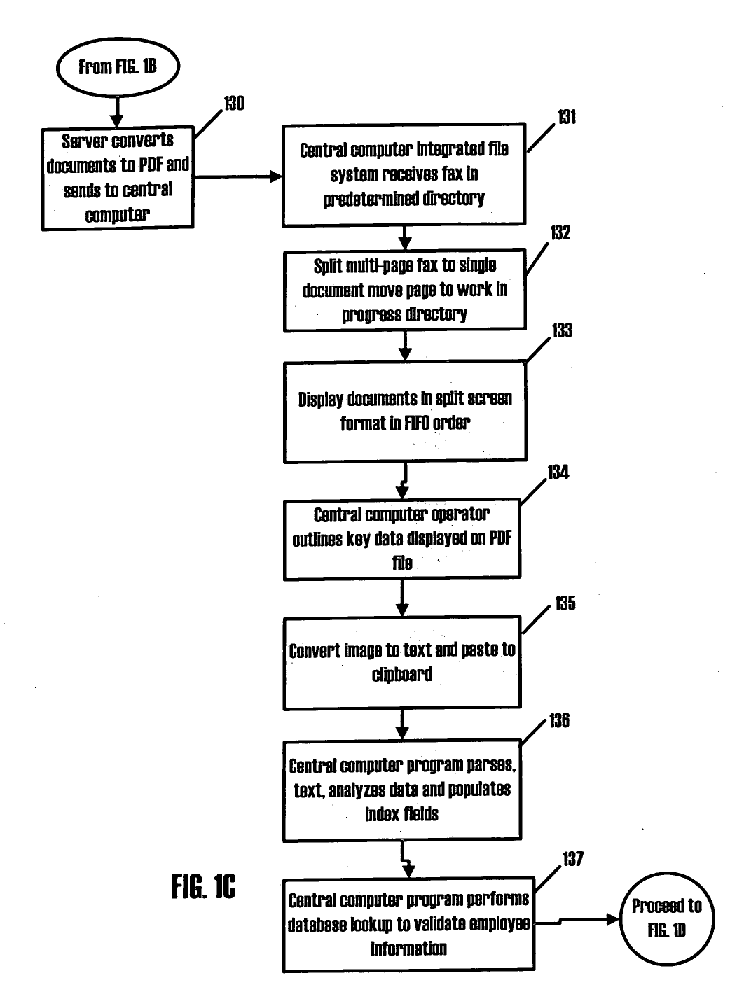

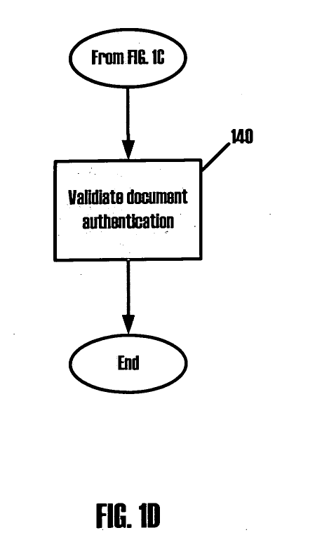

FIG. 1A is a schematic illustration of a system in accordance with an embodiment of the present invention for scanning and archiving electronic documents. In an illustrative embodiment, a branch or remote office 101 prints a label that is then affixed upon (or otherwise associated with) a document, such as a form completed by an employee or a job applicant. The label includes certain information, some of which is from or based on information in the document. For example, the label may include the persons name, social security number, hire date, etc. The document with the affixed label is then converted into an electronic document by use of a device such as a printer/scanner 104, fax machine 105, or other similar device. In alternative embodiments of the present invention, the printer/scanner 104 and fax machine 105 may be integrated into the same device. The electronic document is then transmitted through a network 102 such as the Internet and/or the Public Switched Telephone Network (PSTN), to a central processing center 103. The central processing center 103 may comprise, for example, of one or more fax servers 107, one or more web servers 109, one or more workstations 108, and one or more central computers 110.

The fax servers 107 and web servers 109 accept the digital document data sent over the network 102 to the central processing center 013. The central computer 110 controls the central processing center 103 functionality including storing digital document data to a database 111, accessing the received digital document data, and manipulating the digital document data received by the fax servers 107 and web servers 109. In an exemplary embodiment of the present invention, the central computer 110 functionality is implemented by an IBM AS/400 mainframe computer.

In an illustrative embodiment of the present invention, a user at a central processing workstation 108 can access and manipulate the digital document data via a document processing program 112. The web server 109 includes and/or may provide access to the document processing program 112. In particular, the user can view the digital document and, using the document processing program 112 in accordance with the present invention, select a portion of the digital image, such as part or all of the label, and transpose information from the label into data fields of a database interface of the data processing program 112 for creating, storing and/or validating database records associated with the document. The functionality of the document processing program 112 is discussed in further detail below in reference to FIGS. 1B-15.

In an alternative embodiment of the present invention, workstations 108 may be remotely located from the central processing center 103 and accessible through a LAN, WAN, or other networking means. In alternative embodiments of the present invention the functionality of the fax servers 107, web servers 109 (including the document processing program 112), and central computer 110 can be integrated into a single computer or similar device.

Further, the central processing center 103 may also contain a database 111 for storing data, or in an alternatively embodiment of the present invention the database 111 may be remote from the central processing center 103. The modular components of the central processing center may include a network such as a LAN which can be wireless, wired or a combination thereof. In the illustrated embodiment, the electronic document is received by the fax server 107 and processed utilizing software applications executed on the central computer and/or the web server. A user may access a software application in accordance with the present invention via a workstation 108, and once processed the electronic documents are stored in a database 111 associated with the central computer 110 for subsequent retrieval as needed. The software automatically reads the information on the label, and that information is utilized in processing the document.

With reference to FIGS. 1B-1D, illustrated is a flowchart of a process in accordance with an embodiment of the present invention for creating, scanning, and archiving electronic documents. For purposes of describing this embodiment, the process is that associated with the hiring of a new employee, though the invention is not to be limited by this illustrative embodiment. Initially, in an illustrative embodiment a paper form is filled out by a new employee or job candidate as illustrated by step 113. The paper form may be accompanied by supporting documentation of, for example, proof of citizenship (such as a photocopy of a driver's license or birth certificate, etc.), as illustrated by step 114. A database associated with the central processing center is initialized and a corresponding entry is entered into the database regarding the new employee. The branch office may then initiate a request to a credit agency, such as TransUnion, to conduct a background check, as illustrated by step 115. The credit agency then posts the results via FTP to the central processing center and sends a copy back to the branch office, as illustrated by step 116-119. A database at the central processing center is updated with the new employee information posted from the credit agency, as illustrated by step 120. The update can be done either manually or by an automated script.

A label that contains the employee number is then created to be affixed onto the paper form completed by the new employee, as illustrated by step 121 for conversion to text in the subsequent step. This is most likely done at the branch office. The label may be created by use of a software program, a label maker, or it can be handwritten. In accordance with an aspect of the present invention, the label preferably includes certain readable or recognizable text or markings and at least one character string, preferably an alphanumeric string, with at least some of the readable text on the label encoded therein. In a preferred embodiment, the character string is a 15 character document identification code. The document identification code may reference various information relating to the paper form such as form type, page number, personal identification data (e.g., name, social security, information, address, credit card, student ID, etc.), other identifying data appreciable by one of ordinary skill in the art, or combinations of such identifying data.

Once the label is created and affixed to or otherwise associated with the form, the form and label are sent, such as by email or facsimile, from the branch office to the central processing center, as illustrated by step 122. The label must be created using a specially designed program that will print the appropriate information on the label and also build a 15 character document identification code. The document code preferably is printed using a font that is easily recognized by an optical character recognition program.

The form is received by the central processing center, such as by a private branch exchange, which may then route the incoming fax to a fax server, as illustrated by step 123. The fax server then converts the electronic document into PDF format and sends the PDF file to the central computer, which stores the PDF file in a database associated with the central computer and/or a predetermined directory associated with the central computer, as illustrated by step 130-131. A user at a workstation that is networked to the central computer may then retrieve the PDF file off the central computer and opens the PDF in a reader program having an associated program that splits the multi-page form into individual pages, comprising separate PDF files, as illustrated by step 132. An exemplary program for splitting a PDF would include the following exemplary code:

/ / This cuts a document into pages

| | |
|---|---|
| app.addMenuItem({ | cName: “Cut Up”, cParent: “File”, |
| | cExec: “cutUp( )”, |
| | cEnable: “event.rc = (event.target != null);”, |
| }); | |
| / / setDoc( ); | |
| / / setUser( ); | |
| function setDoc( ) { | |

global.docT ype = app.response({

cQuestion: “Enter G for Guard or J for Janitorial”,
cTitle: “Select document type”,
cDefault: global.docType,
cLabel: “Type:”

});
global.setPersistent(“docType”, true);

}
function setUser( ) {

global.userID = app.response({

cQuestion: “Enter your central computer User ID”,
cTitle: “User ID”;
cDefault: global.userID,
cLabel: “User:”

});
global.setPersistent(“userID”, true);

}
function cutUp( ){

if(global.userID == null || global.userID <= “ ”) {

app.alert(“You must enter your user ID”);
setUser( );
return;
}

if(global.docType != “G” && global.docType != “J”){

app.alert(“Document type code must be G or J”);
setDoc( );
return;
}

/* Extract Pages to Folder */
/ / regular expression acquire the base name of file

var re = /. *V|\.pdf$/ig;
console.println(this.path);
var pathname = this.path;
var GorJ = “JANITORIAL”;
if(global.docType == “G”) GorJ = “GUARD”;

/ / filename is the base name of the file Acrobat is working on

var filename = this.path.replace(re,“ ”);
try {

for (var i = 0; i < this.numPages; i++)
this.extractPages(

{

nStart: i,
cPath: “/P/”+GorJ +“/” + global.userID + “/” +
filename+“_” + i

+“.pdf”

});
} catch (e) {
console.println(“Aborted: ” + e)
}
Archive(pathname)
}

function Archive(PathName)
{

var CURL = “http://localhost:7080/ArchiveDoc/services/
ArchiveDoc”;
SOAP.wireDump = false;
try {
/ / Call the ArchiveDoc SOAP method -- it is an RPC Encoded
method var response = SOAP.request(
{
cURL: cURL,
oRequest: {
“http://soapinterop.org/:MoveDoc”: { FromDoc: PathName }

{,
cAction: “http://soapinterop.org/”
});

}

catch (e) {
console.println(“Aborted: “ + e);

}

}

The PDF files are then placed into a data structure for storage on the central computer or in a database associated with the central computer.

The workstation user then runs a document processing program in accordance with the present invention. In the illustrative embodiment, the document processing program is accessed via a web browser operating on the central processing center workstation. The workstation user selects a PDF from a queue on the central computer and the document processing program begins to process the PDF by running via split screen a PDF reader (e.g., Adobe Acrobat) populated by the selected PDF document in one portion of the screen and an operative database interface adjacent the PDF reader in another portion of the screen, as illustrated by step 133. The workstation user then manipulates a cursor using a device such as a mouse or a keyboard to highlight and select key data on the PDF document, as illustrated by step 134. In accordance with one aspect of the present invention, the selected data on the PDF document comprises at least a portion of the label. A workstation user will then select from the PDF reader's toolbar a button which will run a plug-in such as the Adobe Acrobat plug-in ITSIToolBox™, a product of Image Solutions, Inc., to convert a selected portion of the PDF image to text, which is then pasted to a clipboard of the workstation, as illustrated by step 135. The selected text may comprise part or all of the label created in step 121. A program running on the central computer then takes the text off the clipboard and parses it using logic; the parsed text is then populated into predetermined fields in the operative database interface, as illustrated by step 136. The following software code is an exemplary program for parsing text off the clipboard and inserting it into predetermined fields:

/*----------------------------------------------------------------------------------------
Function: setFieldValue
• • •
----------------------------------------------------------------------------------------*/
function setFieldValue(id,newValue)
{

id2 = eval(id);
id2.value = newValue;
wfInfoDB[id2.id].mdt = true;

}
/*----------------------------------------------------------------------------------------
Function: setFieldValueWithRadio
• • •
function setFieldValueWithRadio(id,thisRef)
{

id2 = eval(id);
newValue =‘ ’;
for (i = 0; i < thisRef.length; i++) {

if (thisRef[i].checked) {
newValue = thisRef[i].value
break }

}
id2.value = newValue;
wfInfoDB[id2.id].mdt = true;

}
/*----------------------------------------------------------------------------------------
Function: setCheckBox
• • •
----------------------------------------------------------------------------------------*/
function setCheckBox(id,CheckedValue,NotCheckedValue,thisCheckBox)
{

if (! thisCheckBox.checked) CheckedValue = NotCheckedValue
id2 = eval(id);
id2.value = CheckedValue;
wfInfoDB[id2.id].mdt = true;

}
/*----------------------------------------------------------------------------------------
Function: getSelectList
• • •
----------------------------------------------------------------------------------------*/
function getSelectList(fldId,SelectList)
{

for (i = 0; i < SelectList.length; i++) {

if (SelectList.options[i].value == fldId.value) {
Select List.options[i].selected = true; }

}

}
/*----------------------------------------------------------------------------------------
Function: getCheckBox
• • •
----------------------------------------------------------------------------------------*/
function getCheckBox(id,CheckedValue,thisCheckBox)

if (id.value == Checked Value)

thisCheckBox.checked = true;

}
/*----------------------------------------------------------------------------------------
Function: viewer
• • •
function viewer(surl)
{

window.open(surl,“viewer”,“height=600,width=700,status,resizable,
scrollbars”);

}
/*----------------------------------------------------------------------------------------
Function: parseIt
• • •
----------------------------------------------------------------------------------------*/
function parseIt(fldId1,fldId2,fldId3,fldValue)
{

fldId1.value = fldValue.value.substr(0,9);
fldId1.value = fldId1.value.replace(/o/g,“0”);
fldId1.value = fldId1.value.replace(s/g,”8”);
fldId2.value = fldValue.value.substr(9,4);
fldId2.value = fldId2.value.replace(/X/g,“ ”);
fldId3.value = fldValue.value.substr(13,2);
fldId3.value = fldId3.value.replace(/o/g, “0”);

}
/*----------------------------------------------------------------------------------------
Function: parseIt2
• • •
function parseIt2(fldId1,fldId2,fldValue)
{

fldId1.value = fldValue.value.substr(0,6);
fldId1.value = fldId1.value.replace(/o/g,“0”);
fldId1.value = fldId1.value.replace(S/g,“8”);
fldId2.value = fldValue.value.substr(6,6);
fldId2.value = fldId2.value.replace(/o/g,“0”);
fldId2.value = fldId2.value.replace(/S/g, “8”);

}

Another software program processed by the central computer may then validate the parsed text by performing a database query to located the employee information stored on a database to compare the parsed text and the employee information stored on that database, as illustrated by step 137. If they match, then the text is validated and the PDF file is deemed by the system to be authentic, as illustrated by step 140. The PDF image is then stored and archived using, at least in part, the data parsed from the label. In an alternative embodiment of the present invention, one or more of the above software programs for splitting the multi-page form into individual pages to comprise separate PDF files, parsing text off the clipboard and inserting it into predetermined fields, validating the parsed text, and other software programs associated with the present invention may be included in the document processing program 112.

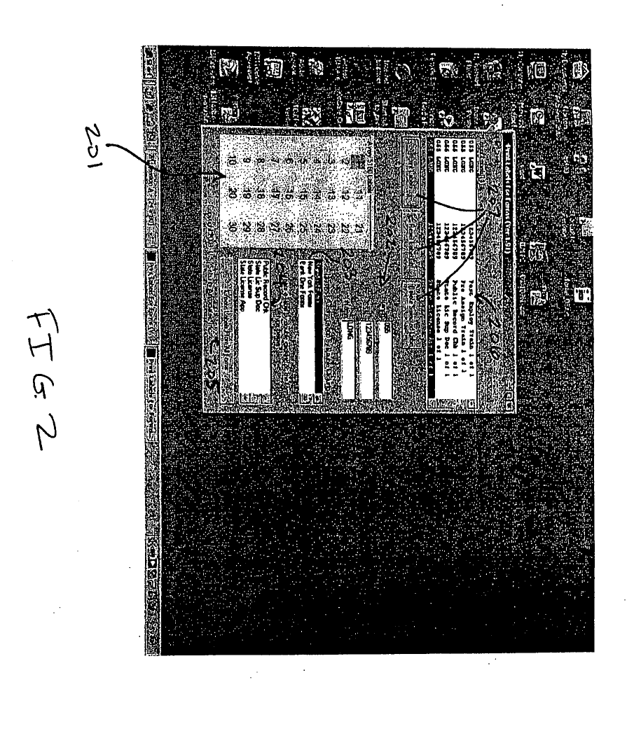

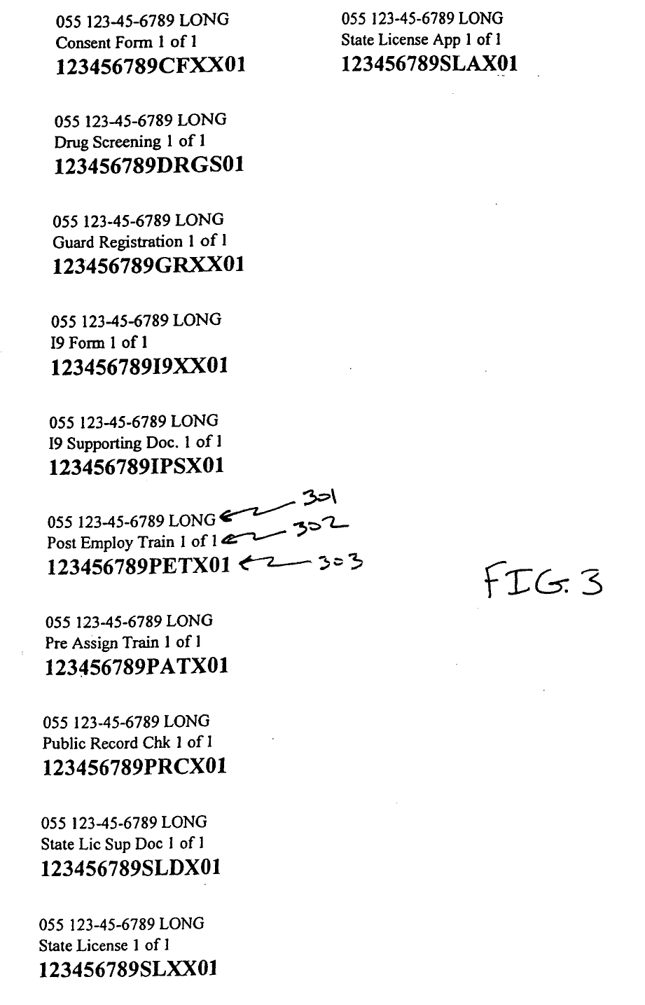

FIGS. 2-3 illustrate an example of the production of the printed labels used on the forms in the branch offices. Initially, in the illustrative embodiment printed labels can be created from the use of software, a label maker, or other suitable means. In the present embodiment, a software program is used to create labels from and for all types of forms, as illustrated in FIG. 2. This software can receive data from the selected form and other data associated with the employee, and then encode the data into a format that can be printed on a label to be affixed to any form. Alternatively, the label may be incorporated into the content of the form itself.

The present embodiment illustrated in FIG. 2 is of a graphical interface of a software program for creating labels. A workstation user will first select from a selection box 201 the type of label to be created. The workstation user will then enter into a group of textboxes 202 the desired alpha-numeric text to appear on the label. The workstation user will then select the desired form to create the label by first selecting a specific group of forms from a scroll-down box 203. A list of forms under the selected group will then populate under a scroll-down box 204. The scroll-down box will then enable a workstation user to double-click on a specific form from this scroll-down box to create the label. Additionally, a button 205 below the scroll-down box enables a user to create labels for all forms. Once a label is created it is stored in a directory (or database location) associated with the software program and listed in a scroll-down box 206. The workstation user can then print or delete the created label by double-clicking on the appropriate button 207, which include “Print Labels,” “Reset Label List,” and “Delete Selected Label.” A label is then printed by the use of an external device such as a printer. A printed label may contain any type of information such as alpha-numeric text, graphics and pictures.

One embodiment of a printed label contains three strings of alpha-numeric text, as illustrated in FIG. 3. The first string, as illustrated in row 301, may contain the branch office number, a social security number and the last name of the person associated with the social security number. The second string, as illustrated in row 302, may contain the document type and its pagination information. The third string, as illustrated in row 303, may contain encoded data which in this illustration includes the social security number, the document type abbreviated, and the page number of the document. The encoded data may include all or some of the data in rows 301 and 302, and may include other data not printed on the label. Also, the encoded data may include information in its literal form or in a representative form, such as an abbreviated form.

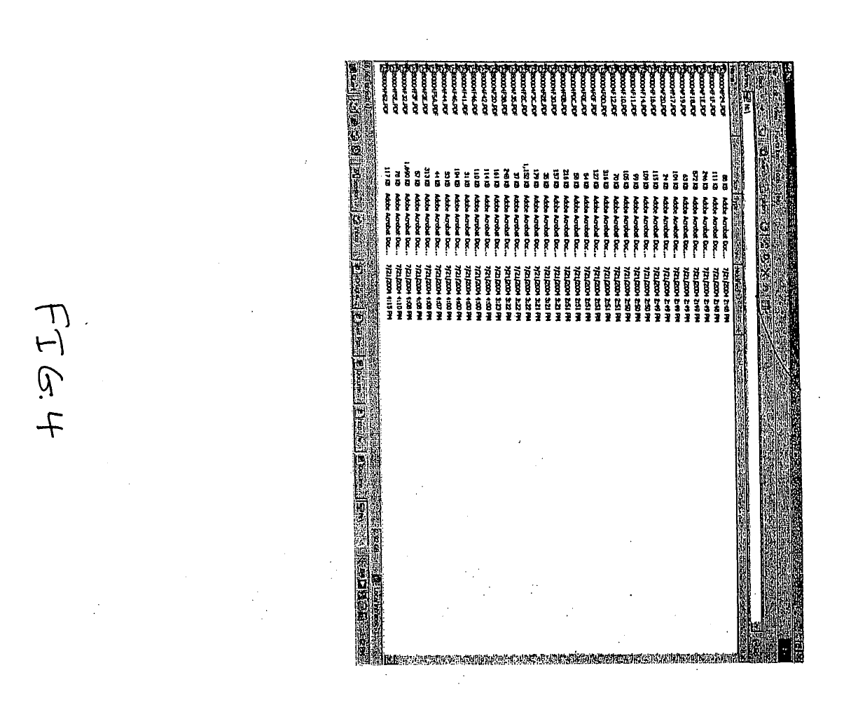

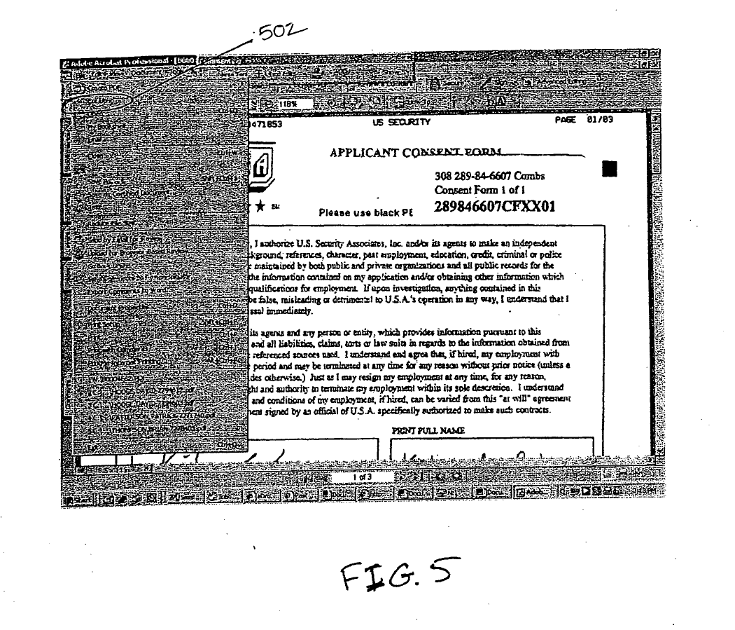

FIGS. 4-10 illustrate user interfaces generated by the central computer and/or the web server (if accessed via the Internet) for the processing of labeled forms for archiving, validating, and storing as electronic documents. According to one aspect of the invention the fax server receives at the central processing center a fax of a labeled form and associated supporting documents and then converts the form associated supporting documents into a PDF file. The PDF is then sent and stored on the central computer or a database associated therewith. The illustrated embodiment of the present invention includes a queue of PDF files on the central computer as received from the fax server. A workstation user navigates to a directory location where the PDFs are stored in a queue and selects a PDF file to process, as illustrated in FIG. 4. The PDF is opened in a reader program. The reader program includes an associated program that splits the multi-page form into individual pages, each being a separate PDF file. For example, a “cut up” option 502 may be selected, as illustrated in FIG. 5. The PDF files are then placed into a data structure for storage on the central computer. In the present embodiment, each individual PDF is stored in a queue on the central computer.

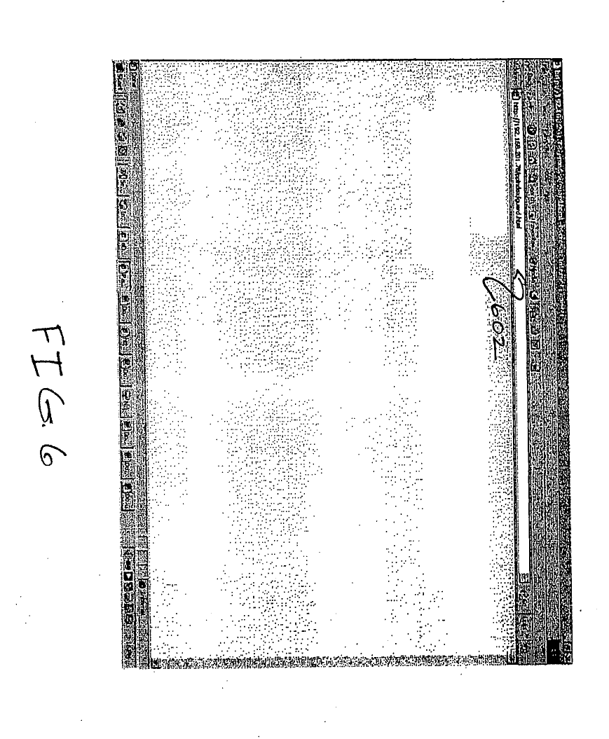

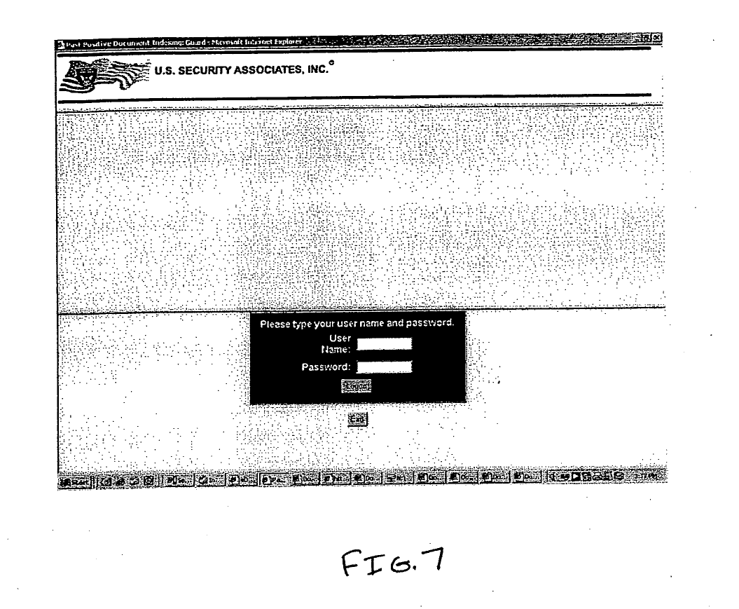

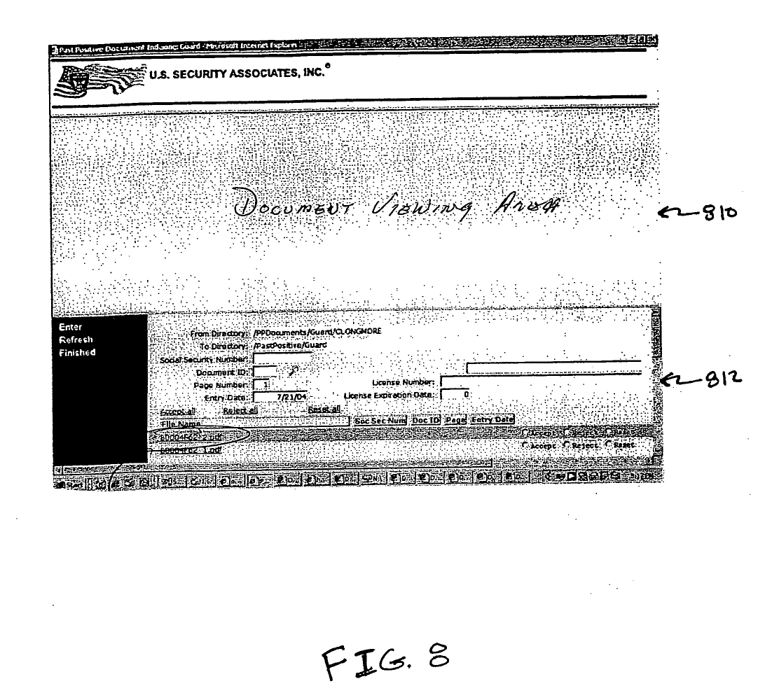

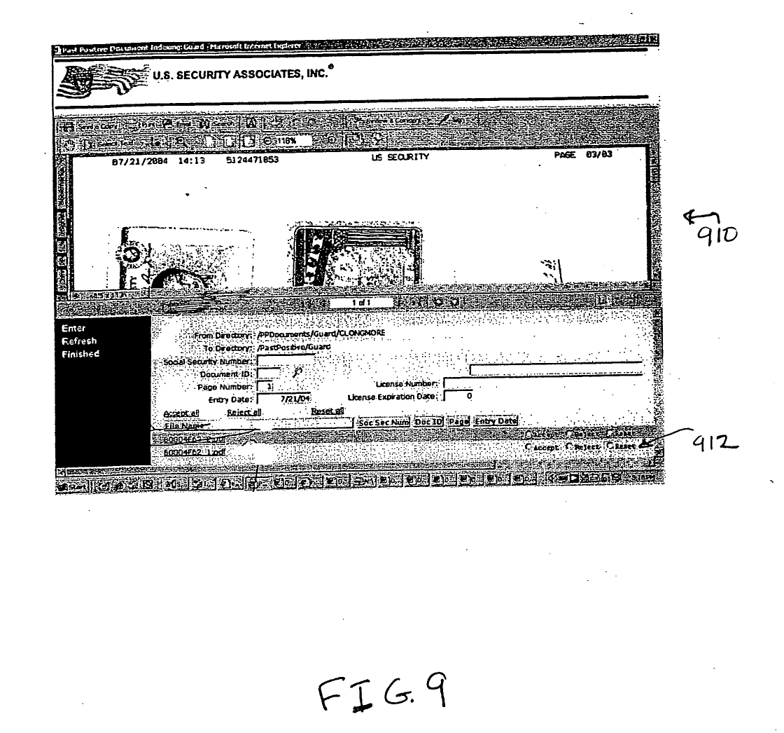

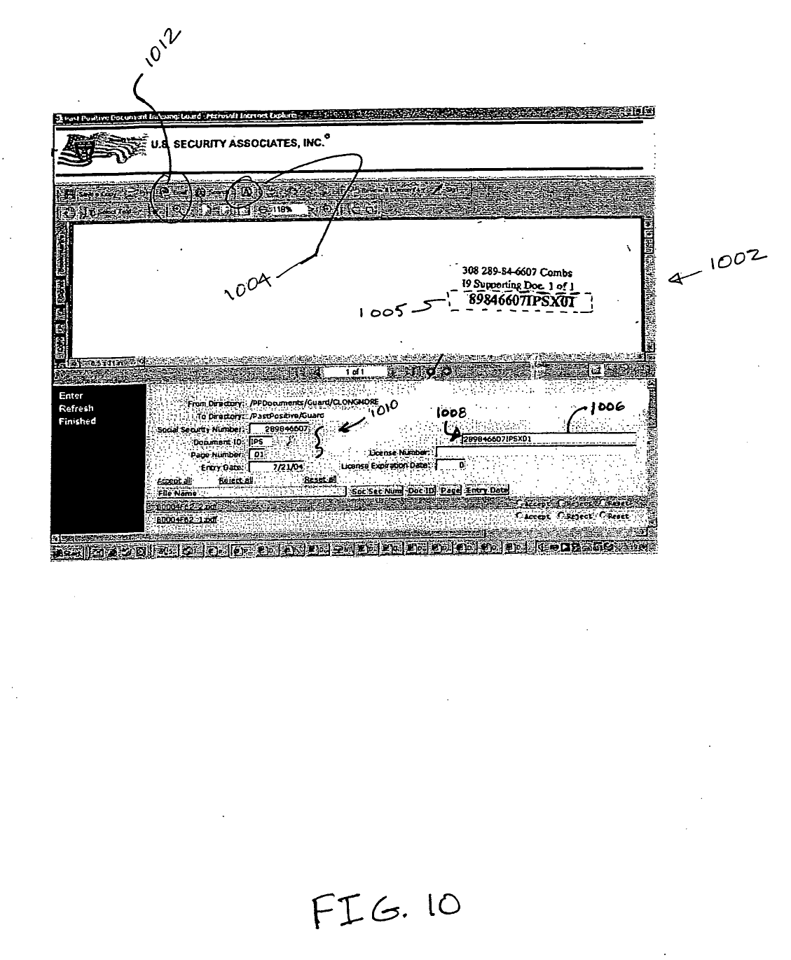

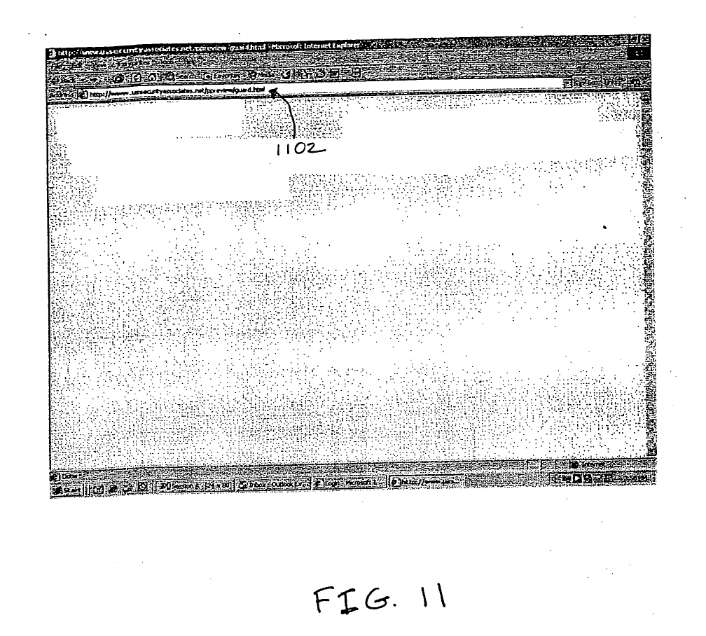

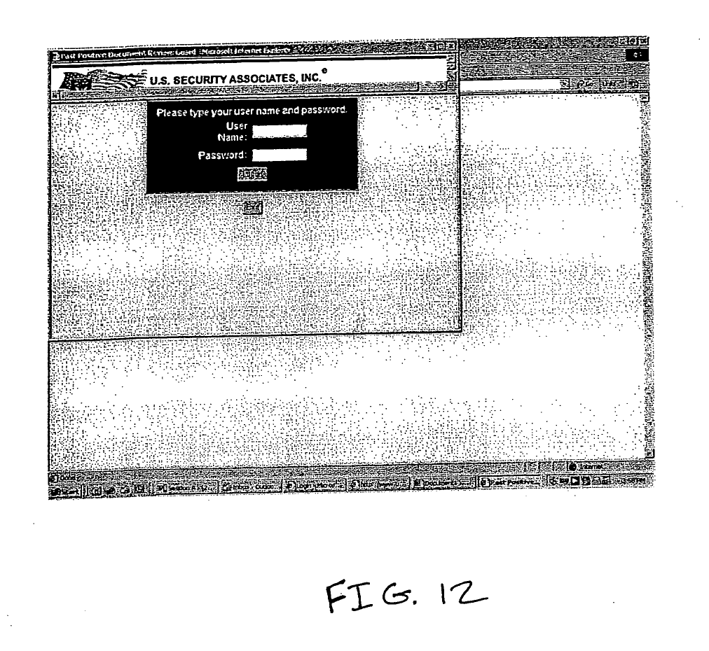

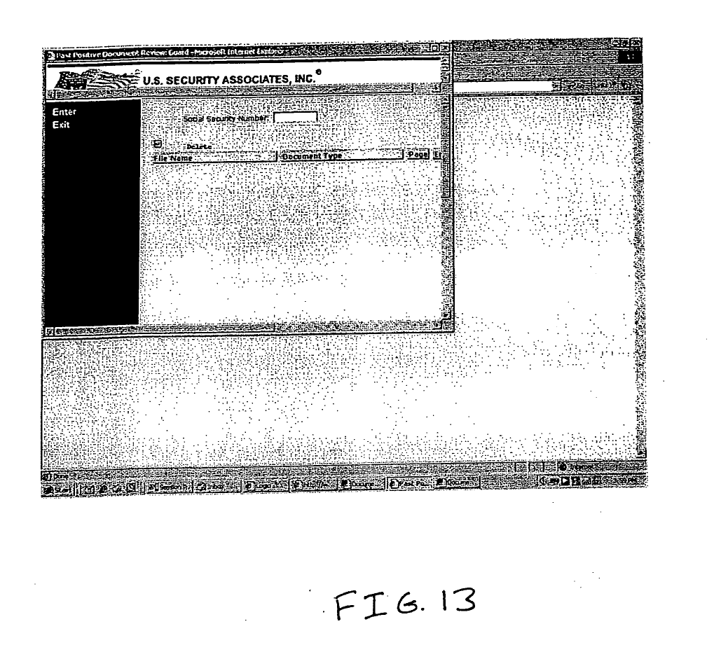

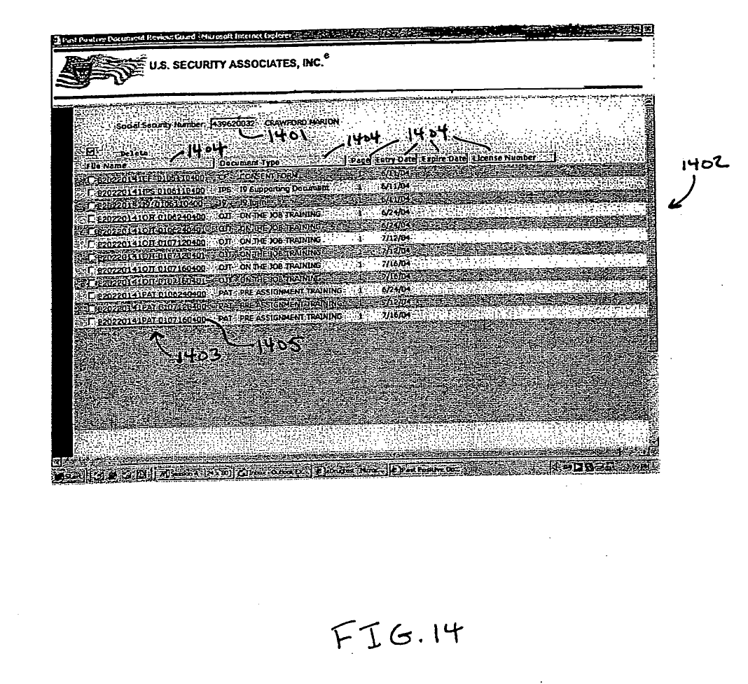

The workstation user then retrieves the PDF files off the central computer. The workstation user opens a web browser and enters the internal web server URL 602 for the document processing program in accordance with the present invention, as illustrated in FIG. 6. The document processing program is executed on a web server. The web server returns a password protected web page that can log the workstation user into the document processing program, as shown in FIG. 7. The document processing program allows authentication and access to files, programs, and databases associated with the central computer. Once the workstation user has entered the correct information into the log-in fields, the user is then authenticated into the central computer for enumerated access.

The workstation user can then select a file such as a PDF file from the central computer to process. The document processing program 112 accomplishes the processing of the PDF by running via split screen a document viewing area 810 and an operative database interface 812 that can initiate functions of the document processing program, as illustrated in FIG. 8. In the present embodiment, the viewing area is populated by an Adobe PDF reader and the operative database interface includes several fields that are populated by text, user selected functions, and a display queue of PDF files on the central computer, as illustrated in FIG. 9. The workstation user then selects a PDF from the queue 912 for processing and a PDF reader displaying the selected PDF image in the queue 912 populates the document viewing area 910 while several fields in database interface 812 are automatically populated with data. The workstation user then selects and highlights the desired portion of the PDF image in the viewing area 1002 for image to text conversion, as illustrated in FIG. 10. The workstation user can then select from the PDF reader's toolbar a button 1004 which will execute an image to text program, such as ITSIToolBox™, to convert the selected portion 1005 of the image to text. ITSIToolBox™ converts the image into text, which is then placed onto a scratch pad available from the operating system for use by the document processing program. The text can then be populated into text fields of the operative database interface of the document processing program for validation. For example, an encoded text field 1006 receives the text, that is, the encoded alpha-numeric string 1008. The encoded string is then parsed using logic from the program for parsing text off the clipboard and inserting it into predetermined fields incorporated by reference above, to populate specified fields 1010 of the operative database interface. The user can then compare the data in fields 1010 with that of the PDF image in the viewing area 1002. In the present embodiment, the illustration shows that the encoded social security number, document type abbreviation, and page number are parsed out from the encoded alpha-numeric string 1008 and inserted into the fields 1010 designated Social Security Number, Document ID, and Page Number respectively. The parsed data may by use of an automated script populate index fields in the database.

Validation of the parsed data can occur by the user or by an associated program. The program would contain logic which would compare the information in a particular field of the operative database interface to a specific field in a database. In the present embodiment, the document processing program contains logic which compares the Social Security Number to a field in a database. It will be appreciated that the user has the flexibility to change the text in a field if the data in that field does not pass validation. As such, if the text fails to validate, then the user may correct the field and re-validate it. If the workstation user finds that the data on the label is wrong or will not validate then the workstation user can select the email button 1012 of the toolbar to return the PDF document back to the corresponding branch office for evaluation. Once validated the data may be stored and/or indexed in a searchable form in a database, such as a database of employee records or the like, and the PDF image is stored and archived with the corresponding database entry. It will also be appreciated that the loading and use of the Document Processing Program does not require a huge amount of hardware resources. As a result, the Document Processing Program is less costly and does not hinder the operating efficiency of the system it is running on.

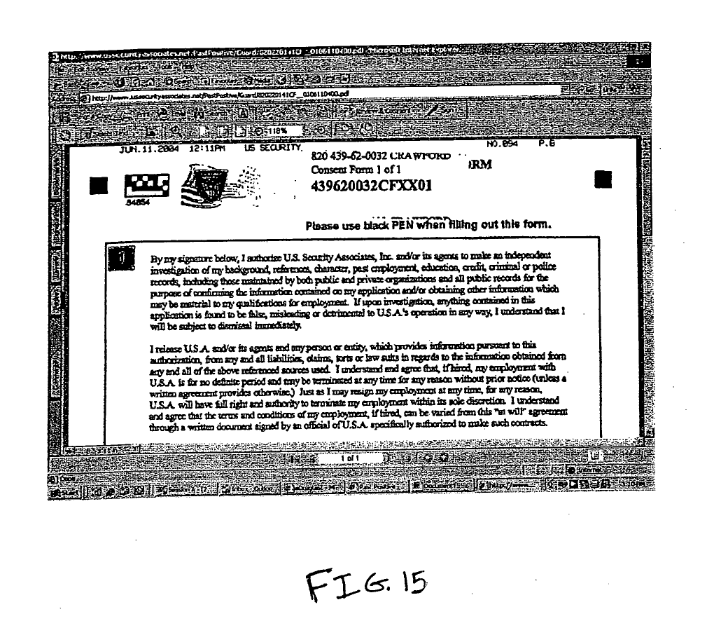

FIGS. 11-15 illustrate the retrieval of a processed PDF for use by a requesting workstation user. The workstation user runs the Document Retrieval Program via web browser. The document retrieval program allows authentication and specific access to files and programs stored and/or executed on the central computer. The workstation user opens a web browser and enters an external web server URL 1102 for the document retrieval program, as illustrated in FIG. 11. The document retrieval program may be stored and executed on a web server or other components of the central processing center. The web server would return a password protected web page that can login a workstation user into the document retrieval program as shown in FIG. 12. Once the workstation user has entered the correct information, the user is then authenticated into the central computer for enumerated access. The workstation user is presented with a form that connects to a database associated with the central computer for query and retrieval of the sought document, as illustrated in FIG. 13. The form may contain as illustrated, a field for Social Security Number. The workstation user enters the desired information into the Social Security Number field and the Document Retrieval Program queries and retrieves the desired document, as illustrated in FIG. 14. In the present embodiment, a Social Security Number is entered into the Social Security Number field 1401 for querying the database. The results of the query will be returned and populated into a table 1402, which displays a list of all PDF files stored in the database that are associated with the entered Social Security Number. Links 1403 to the all the PDF files are displayed under a column heading 1404, such as file name and other corresponding information regarding the PDF file is also displayed under a corresponding file name 1405. A workstation user selects the desired PDF file by using a device such as a mouse, keyboard, or similar device. Once the PDF file is selected, an Adobe PDF reader is opened displaying the retrieved PDF image, as illustrated in FIG. 15. The user is free to use the functions of the Adobe PDF reader and any associated plug-in to perform a task with the PDF image.

Many modifications and other embodiments of the inventions set forth herein will come to mind to one skilled in the art to which these inventions pertain having the benefit of the teachings presented in the foregoing descriptions and the associated attachments. Therefore, it is to be understood that the inventions are not to be limited to the specific embodiments disclosed and that modifications and other embodiments are intended to be included within the scope of the present disclosure. Although specific terms are employed herein, they are used in a generic and descriptive sense only and not for purposes of limitation.

That which is claimed:

1. A method for processing paper documents for electronic storage and retrieval, comprising:
generating a label to be associated with a document, wherein the label includes at least one character string containing readable text and at least a portion of the readable text on the label is encoded;
associating the label with the document;
converting the document to a digital format;
transmitting the digital document to a central processing center;
separating the digital document into two or more individual pages;
presenting the digital document to a user with a viewer program;
receiving user input identifying a certain portion of the label and imaging that portion of the label;
converting the imaged portion of the label to textual data relating to at least the document and the contents of the document; and
populating data fields of an archiving program with the textual data for use in archiving the document.

2. The method of claim 1, wherein the encoded readable text on the label includes a document identification code includes at least one of a form type, page number and personal identification data.

3. The method of claim 2, wherein the document identification code includes at least 15 characters.

4. The method of claim 1, wherein associating the label with the document comprises affixing the label to the document.

5. The method of claim 1, wherein associating the digital format is PDF.

6. The method of claim 4, wherein separating the digital document into two or more individual pages further includes creating a PDF file of each individual page.

7. The method of claim 1, wherein the viewer program is a web browser.

8. The method of claim 1, wherein converting the imaged portion of the label to textual data includes pasting the textual data to a clipboard, parsing the textual data off the clipboard and inserting it into at least one predetermined field.

9. The method of claim 1, further comprising correcting the textual data that is populating the data fields.

10. A method for processing paper documents for electronic storage and retrieval, comprising:
generating a label to be associated with a document, wherein the label includes at least a document identification code;
associating the label with the document;
converting the document to a digital format;
transmitting the digital document to a central processing center;
separating the digital document into two or more individual pages;
presenting the digital document to a user with a viewer program;
receiving user input identifying a certain portion of the label and imaging that portion of the label;
converting the imaged portion of the label to textual data relating to at least the document and the contents of the document;
populating data fields of an archiving program with the textual data for use in archiving the document; and
validating the captured data.

11. The method of claim 10, wherein the validation of the captured data includes comparing information in a particular field of an operative database interface to a specific field in a database.

12. The method of claim 11, further comprising, correcting data in the particular filed of an operative database interface.

13. The method of claim 10, further comprising storing the digital document in a database associated with the central processing center.

14. The method of claim 13, further comprising retrieving the stored digital document from the database.

15. The method of claim 14, wherein retrieving the stored digital document includes filling out a form connected to the database, wherein the form contains a plurality of fields.

16. A system for processing paper documents for electronic storage and retrieval, comprising:
at least one scanning device for converting a paper document into an electronic document;
a central processing center in communication with the at least one scanning device over a network, wherein the central processing center contains, at least one server, at least one central computer, and at least one workstation,
wherein the at least one workstation contains a user interface for accessing, through the at least one server, a plurality of software applications stored in at least one database associated with the at least one central computer,
wherein the plurality of software applications contain executable instructions for performing the following functions on the at least one central computer:
(1) presenting the electronic document to a user;
(2) receiving user input identifying a certain portion of a label associated with the electronic document and imaging that portion of the label;
(3) converting the imaged portion of the label to textual data relating to at least the electronic document and the contents of the electronic document; and
(4) populating data fields of an archiving program stored on the at least one database with the textual data for use in archiving the document.

17. The system of claim 16, wherein the network is the Internet.

18. The system of claim 16, wherein the at least one workstation is located remote from the central processing center and communicates with the central processing center over a secured network connection.

19. The system of claim 16, wherein the central processing center includes a private branch exchange, wherein the private branch exchange receives data from the at least one scanner over the network and routes the received data to the at least one server of the central processing center.

20. The system of claim 19, wherein the at least one server of the central processing center converts the electronic document to PDF format and sends it to a predetermined database location associated with the at least one central computer of the central processing center.
